(19) United States
(12) Patent Application Publication
(10) Pub. No.: US 2007/0081688 A1
(43) Pub. Date: Apr. 12, 2007

(54) Earphone

(76) Inventor: Hsien-Ta Chen, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/246,059

(22) Filed: Oct. 11, 2005

(51) Int. Cl. H04R 25/00

(52) U.S. Cl. 381/370; 381/371

(57) ABSTRACT

An earphone has a body, a connecting element and a speaker. The body has a distal end, a joint, a core, a base, an outer side, an inner side, and a connecting cylinder. The joint extends from the distal end. The base is formed in the core. The connecting cylinder is formed on the inner side. The connecting element has an inner side and an outer side. The outer side is formed annularly multiple tabs and multiple circular recesses. The multiple circular recesses are formed respectively between the multiple tabs and hold respectively the multiple protrusions inside. The speaker is mounted in the base. Therefore, manufacturers can switch between the different connecting elements to provide both a plug-type earphone and an insert-type earphone during the manufacturing process.

### BACKGROUND OF THE INVENTION

1. Field of the Invention

The present invention relates to an earphone, especially to an earphone with superior acoustics, comfort, and lower production cost.

2. Description of the Related Art

A person can listen to personal music or radio broadcasts in public without disturbing others by using an earphone. With reference to FIGS. 5 and 6, a common traditional plug-type earphone is shown. The plug-type earphone has a body (60), a retaining cap (62), a speaker (61), and a grill (63). The retaining cap (62) is mounted over the open end of the body (60) and holds the speaker (61) in the body (60). The grill (63) is then mounted in or over the retaining cap (62) to protect the speaker (61). The diameter of the retaining cap (62) and the grill (63) is such that the plug-type earphone can be inserted in the outer ear, with the grill (63) against the auricle.

With reference to FIG. 7, a traditional insert-type earphone is shown. The insert-type earphone is different from the plug-type earphone. The diameter of the insert (72) of the insert-type earphone is smaller than the diameter of the retaining cap of the plug-type earphone. And an extension (73) connects the body (70) and the insert (72). The insert (72) is covered with a soft cushion material (74). The insert-type earphone is inserted into the user's ear canal. Therefore, the plug-type earphone and the insert-type earphone can suit different types of users.

In the manufacturing process, the elements of a plug-type earphone and an insert-type earphone are not interchangeable. Manufacturers would need two different molds to produce both the plug-type earphone and the insert-type earphone. This then increases the manufacturing cost.

### SUMMARY OF THE INVENTION

The objective of the present invention is to provide an interchangeable earphone. The earphone comprises a body, a connecting element, and a speaker. The body has a distal end, a joint, a core, a base, an outer side, an inner side, and a connecting cylinder. The joint extends from the distal end. The base is formed in the core. The connecting cylinder is formed on the inner side. The connecting element has an inner side and an outer side. The outer side is formed annularly multiple tabs and multiple circular recesses. The multiple circular recesses are formed respectively between the multiple tabs and hold respectively the multiple protrusions inside to connect the connecting element to the body. The speaker is mounted in the base.

The body used for both types of earphone is the same and just the connecting elements are different. Therefore, manufacturers can switch between the different connecting elements to provide both a plug-type earphone and an insert-type earphone during the manufacturing process.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of the present invention;

FIG. 2 is an exploded perspective view of the first embodiment in FIG. 1;

FIG. 3 is a perspective view of a second embodiment of the present invention;

FIG. 4 is an exploded perspective view of the second embodiment in FIG. 3;

FIG. 5 is a perspective view of a traditional plug-type earphone;

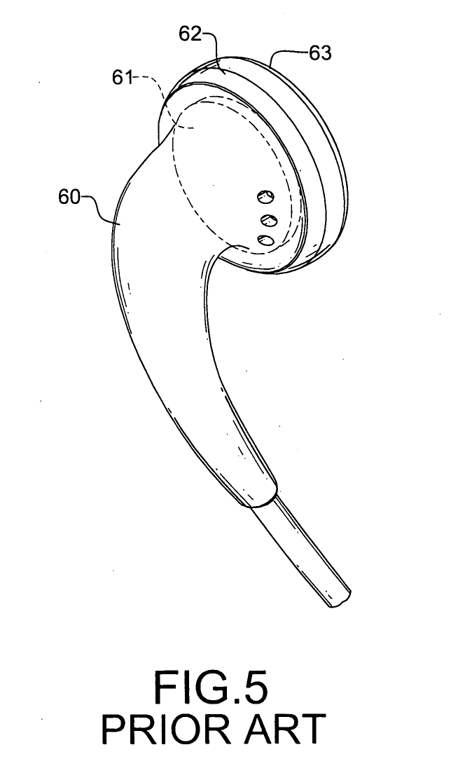

FIG. 6 is an exploded view of the traditional plug-type earphone in FIG. 5;

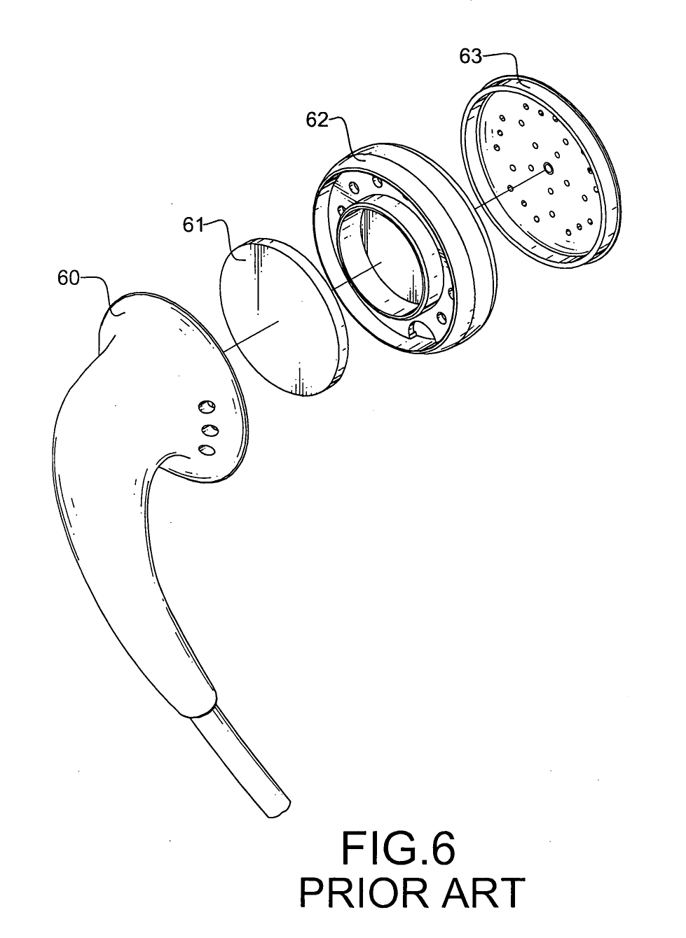

FIG. 7 is a perspective view of a traditional insert-type earphone.

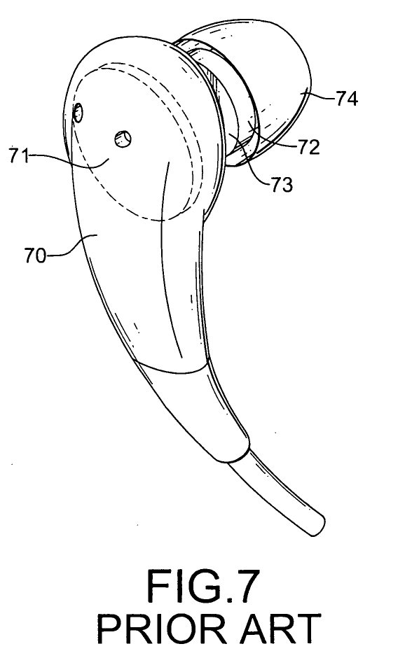

### DETAILED DESCRIPTION OF THE PREFERRED EMBODIMENTS

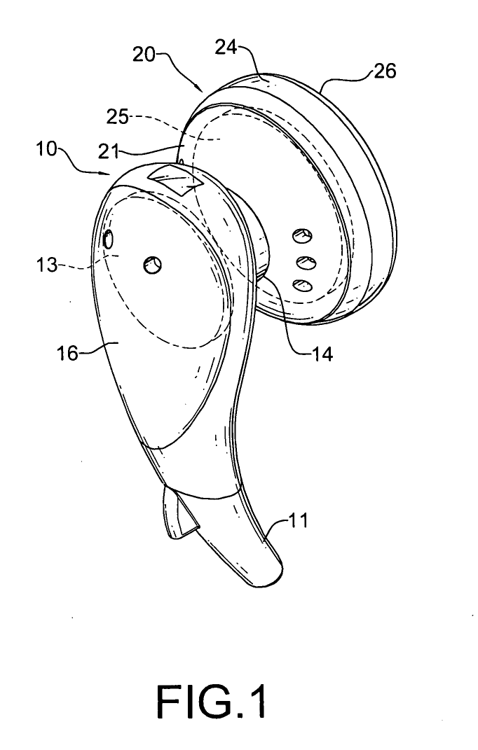

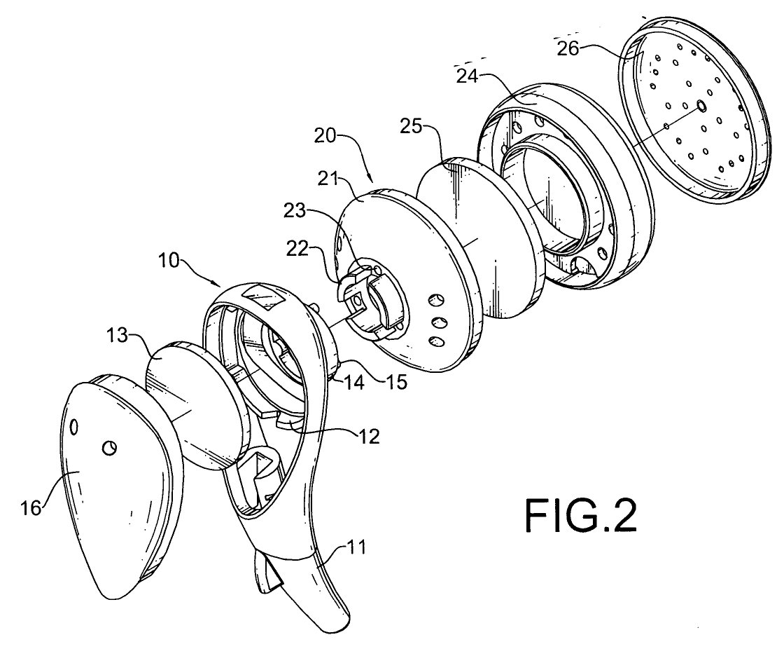

With reference to FIGS. 1 and 2, a first embodiment of the earphone in accordance with the present invention comprises a body (10), a connecting element (20) and multiple speakers (13,25).

The body (10) has a joint (11), a distal end, a core, a base (12), an outer side, an inner side, a connecting cylinder (14), multiple protrusions (15), and a panel (16). The joint (11) is formed on the body (10) and extends from the distal end to receive a wire. The panel (16) is attached to the outer side of the body (10). The base (12) is formed in the core. The connecting cylinder (14) is formed on the inner side of the body (10). The multiple protrusions (15) are formed on the connecting cylinder (14).

The connecting element (20) has a dish (21), an annulus support (24), and a cap (26). The dish (21) has an outer side, an inner side, multiple tabs (22), and multiple circular recesses (23). The multiple tabs (22) are formed annularly on the outer side. The multiple circular recesses (23) are fonned respectively between the multiple tabs (22) on the outer side. The annulus support (24) is attached at the inner side on the dish (21). The cap (26) is connected to the annulus support (24).

In a preferred embodiment, two speakers (13,25) are arranged in the earphone, and one of the speakers (13) is mounted in the base (12) and the other speaker (25) is mounted in the annulus support (24). The multiple protrusions (15) are fastened respectively to the multiple circular recesses (23). Thus, the connecting element (20) can be fixed onto the body (10). The above earphone has two speakers to improve the quality of the acoustics.

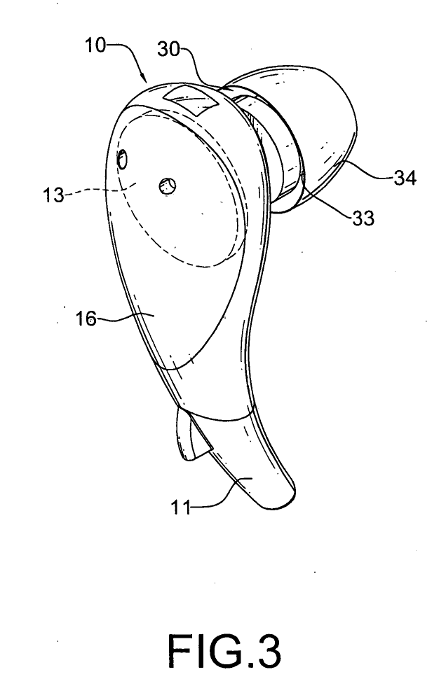

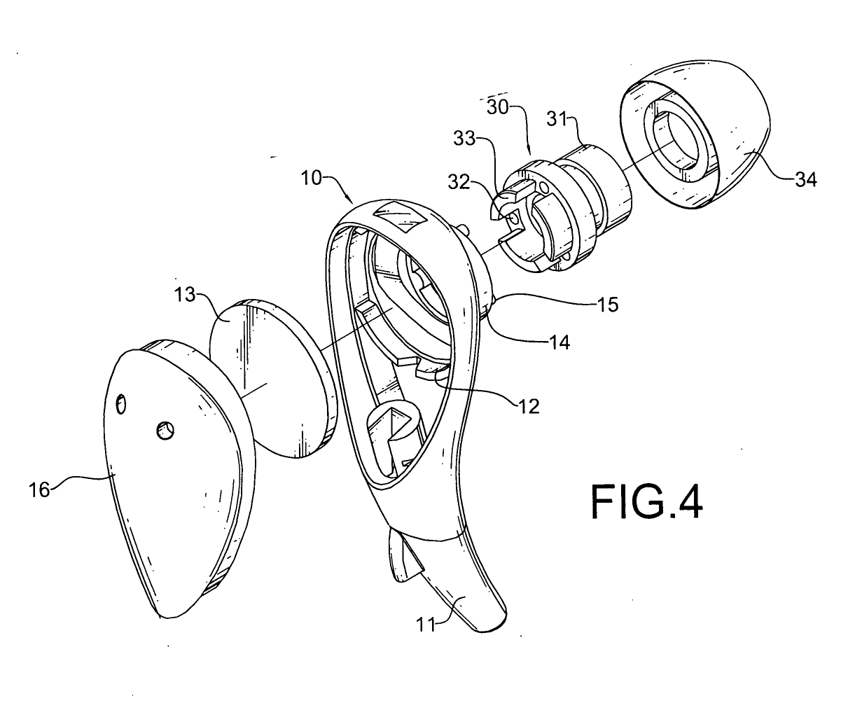

With reference to FIGS. 3 and 4, a second embodiment of the earphone in accordance with the present invention is shown in which the body (10) is similar to the body (10) in the first embodiment. However, an annular connecting element (30) is used in the second embodiment, which is different from the connecting element (20) used in the first embodiment. The annular connecting element (30) has an inner side, an outer side, multiple tabs (31), multiple circular recesses (32), an extension (33), and a cushion (34). The extension (33) has an end. The multiple tabs (31) are formed annularly on the outer side. The multiple circular recesses (32) are formed respectively between the multiple tabs (31) on the outer side. The cushion (34) is attached to the end of the extension (33). The multiple protrusions (15) are fastened respectively to the multiple circular recesses (32). Thus, the annular connecting element (30) can be fixed onto the body (10).

Because the body (10) can accept different connecting elements (20,30), manufacturers can switch the different connecting elements (20,30) during the manufacturing process to produce plug-type earphones or insert-type earphones in accordance with the market. The manufacturers would not need extra molds to produce other types of earphones, thereby reducing production cost.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An earphone comprising:
a body having
a distal end,
a joint extending from the distal end,
a core,
a base formed in the core,
an outer side,
an inner side,
a connecting cylinder formed on the inner side, and
multiple protrusions formed on the connecting cylinder;
a connecting element connected to the body and having
an inner side, and
an outer side having
multiple tabs formed annularly on the outer side, and
multiple circular recesses formed respectively between the multiple tabs on the outer side and holding respectively the multiple protrusions inside to connect the connecting element to the body; and
a speaker mounted in the base.

2. The earphone as claimed in claim 1, wherein
the connecting element further comprises a dish having
an outer side formed with the multiple tabs and the multiple circular recesses to connected to the connecting cylinder, and
an inner side; and
the body further comprises a cap connecting to the inner side of the dish.

3. The earphone as claimed in claim 2, wherein the connecting element more further comprises an annulus support attached at the inner side on the dish.

4. The earphone as claimed in claim 3, wherein the earphone further comprise a speaker mounted in the annulus support.

5. The earphone as claimed in claim 1,wherein the connecting element further comprises an extension formed on the inner side.

6. The earphone as claimed in claim 5, wherein a cushion is attached to the end of the extension.
